(19) United States
(12) Patent Application Publication
(10) Pub. No.: US 2009/0029173 A1
(43) Pub. Date: Jan. 29, 2009

(54) TWO-COMPONENT ANTICORROSIVE PAINT, USE THEREOF AND METHOD FOR PRODUCING THE SAME

(75) Inventors: Christian Schramm, Hersbruck (DE); Thomas Voit, Auerbach (DE); Georg Wagner, Tholey (DE); Wolfgang Forster, Essen (DE)

Correspondence Address: OSTROLENK FABER GERB & SOFFEN, 1180 AVENUE OF THE AMERICAS, NEW YORK, NY, 100368403, US

(73) Assignees: ECKART GMBH & CO. KG, Fuerth (DE); NTC NANO TECH COATINGS GMBH, Tholey (DE)

(21) Appl. No.: 11/917,006

(22) PCT Filed: Jun. 8, 2006
(86) PCT No.: PCT/EP06/05479

§ 371 Date: Apr. 16, 2008

(30) Foreign Application Priority Data
Jun. 8, 2005 (DE) 10 2005 026 523.5

(51) Int. Cl. C09D 5/08; C09B 67/20; C08K 3/10; B32B 27/38

(52) U.S. Cl. 428/413; 106/14.37; 106/14.35; 524/434

(57) ABSTRACT

A two-component anticorrosion paint comprising metal pigment, epoxy binder component and amine curing agent and containing two components A and B,

of which
Component A comprises
(a1) (x−y)% by weight of metal pigments comprising platelet-type zinc containing metal pigments, where x is 30 to 70,
(a2) from 10 to 50% by weight of at least one epoxysilane and/or epoxy silicone, and
(a3) from 0 to 40% by weight of an organic solvent,
   and
   Component B comprises
(b1) from 2 to 15% by weight of at least one amine curing agent,
(b2) y % by weight of metal pigments comprising platelet-type zinc-containing metal pigments, where y is from 0 to x % by weight,
(b3) from 0 to 40% by weight of an organic solvent,
   the percentages being based on the total weight of the two-component anticorrosion paint and total 100% by weight, with the proviso that the total water content of the two-component anticorrosion paint is not more than 5% by weight, the total content of solvent is not more than 40% by weight, and the total content of the platelet-type zinc-containing metal pigments is at least 20% by weight.

A process for the production of such a paint and to the use thereof.

The invention relates to a two-component anticorrosion paint comprising a metal pigment, an epoxy binder component, and an amine curing agent, and to the use of said anticorrosion paint and to a method for producing the same.

Anticorrosion coatings providing engineering corrosion protection consist of three, and in most cases four, coatings. The undercoat usually contains zinc dust. The zinc pigments serve as sacrificial anodes due to the strongly electronegative character of zinc. Superimposed on the undercoat are one or two layers of paint that predominantly contain platelet-type pigments such as micaceous iron oxide, for example. These platelet-type pigments extend the diffusion paths of water and/or oxygen. Finally, a top coat is applied, which usually consists of a two-component polyurethane system.

These anticorrosion coatings are predominantly used on steel constructions, for example, railway bridges, lattice steel towers, or guard rails on freeways. The efforts to reduce VOC emissions involve a strong interest in reducing the solvent content of such anticorrosion coatings. Furthermore, there exists a strong interest in reducing the elaborate personnel-intensive and cost-intensive application of the quadruple-layer paint structure.

EP 0 808 883 A2 discloses a chromium-free coating composition consisting of a high-boiling organic liquid, metal pigments, for example zinc flakes, a thickener, and from 3 to 20% by weight of an organofunctional silane. The organofunctional silane can be an epoxy-functional silane.

One disadvantage of the composition is its very high water content of from 30 to 60% by 300 weight. Although EP 0 808 883 A2 makes reference to the passivating effect of the silane and optionally added supplementary components, such as phosphates or borates, these compositions do not in practice exhibit sufficient gassing stability due to their high water content. In order to increase the corrosion resistance of the coating composition, major amounts of a high-boiling organic liquid preferably of from 15 to 25% by weight are added to the coating composition. The use of major amounts of a high-boiling organic liquid is not desirable from the aspects of drying technology and ecology.

EP 1 199 339 A1 discloses another chromium-free coating composition, which comprises from 20 to 70% by weight of water, a low-boiling organic liquid, metal pigments, for example zinc flakes, a thickener, from 3 to 20% by weight of an organofunctional silane, and a wetting agent. In order to increase the corrosion resistance of the coating composition in view of the very high content of water, preferably from 15 to 25% by weight of low-boiling organic liquid is used. In view of the not inconsiderable emissions of organic liquid, it would be desirable to have an anticorrosion composition which does not require the use of substantial amounts of organic liquids in order to avoid corrosion of the zinc flakes.

DE 43 23 062 A1 discloses a water-based zinc dust coating material. The latter consists of two components as follows:

### Component A:

from 0.5 to 10% by weight of amine curing agent,
from 1 to 30% by weight of water-dilutable solvents,
from 45 to 95% by weight of Zn-powder or Zn-dust, and

### Component B:

from 1 to 25% by weight of epoxy curing agent.

This composition corresponds to the conventional Zn-dust corrosion coatings. Conventional epoxy curing agents and amine curing agents are used. Such anticorrosion coatings are used as primers and require the usual quadruple-layer paint coating technique similarly to the anticorrosion coatings specified by the teachings of EP 0 808 882 A2 and EP 1 199 339 A1.

In view of the time-consuming and cost-intensive painting operations on, say, iron and steel constructions such as bridges, buildings, etc., it would be desirable to have an anticorrosion composition that does not require the application of two or three further layers on the priming layer.

EP 1 191 074 A1 discloses two-component shop primer compositions. The first component of the shop primer consists of an omega aminosilane, a relatively strong acid, an epoxysilane as well as one or more pigments, of which at least 25% by weight is required to have conductive properties.

The second component consists of finely divided zinc, both Zn-dust and Zn-flakes being suitable.

These compositions are largely solvent-free and anhydrous. However, applications of these compositions other than as shop primers, i.e., as primary anticorrosion layer, is not feasible, but the anticorrosion layer applied using the shop primer must be provided with additional coatings in order to achieve a long-term anticorrosion effect.

DE 101 52 853 A1 discloses a curable mixture based on hydrolysis products of organosilanes, which contain epoxysilanes as the necessary components and at least one blocked polyisocyanate. The use of such a curable mixture together with Zn-pigments in anticorrosion applications is not described.

DE 100 39 404 A1 discloses a method for producing a curable mixture based on hydrolysis products of organosilanes, which contain epoxysilanes as necessary components in addition to pigments or fillers. The epoxysilanes can be caused to react with aromatic polyols. Aluminum pigments and Zn-dust are described as pigments.

It is an object of the present invention to provide a solvent-free anticorrosion paint, by means of which it is possible to create an anticorrosion paint system consisting of only one or two layers of paint. The total coating thickness of this monolayer or double-layer anticorrosion paint system should be well below the usual coating thicknesses applied hitherto. The system is required to meet the test specifications set forth in ISO 12944 C5-I.

It is another object of the present invention to provide a method for producing such an anticorrosion paint system.

The object is achieved by providing a two-component anticorrosion paint which comprises a metal pigment, an epoxy binder component, and an amine curing agent, which two-component anticorrosion paint comprises two components A and B, of which

Component A comprises
(a1) (x−y)% by weight of metal pigments comprising platelet-type zinc-containing metal pigments, where x is 30 to 70,
(a2) from 10 to 50% by weight of at least one epoxysilane and/or epoxy silicone, and
(a3) from 0 to 40% by weight of an organic solvent,
   and
   Component B comprises
(b1) from 2 to 15% by weight of at least one amine curing agent,
(b2) y % by weight of metal pigments comprising platelet-type zinc-containing metal pigments, where y is from 0 to x % by weight,
(b3) from 0 to 40% by weight of an organic solvent,
   these percentages being based on the total weight of the two-component anticorrosion paint and total 100% by weight, with the proviso that the total water content of the two-component anticorrosion paint is not more than 5% by weight, the total content of solvent is not more than 40% by weight, and the total content of the platelet-type zinc-containing metal pigments is at least 20% by weight.

The object is further achieved by a method for producing a two-component anticorrosion paint according to any one of claims 1 to 18, which method comprises the following steps:
a) taking from 10 to 50% by weight of epoxysilane, which may be optionally oligomerized or polymerized by the controlled addition of water,
b) taking from 2 to 15% by weight of an amine curing agent
c) homogenously mixing (x−y)% by weight of the metal pigments comprising platelet-type zinc-containing metal pigments, where x=30 to 70, with the epoxysilane, to form component A and y % by weight of metal pigments comprising platelet-type zinc-containing metal pigments with the amine curing agent, where y is from 0 to x % by weight, to form component B.

Furthermore, the object of the invention is achieved by a method for producing a two-component anticorrosion paint, in which component A and component B are mixed with each other. The two-component anticorrosion paint of the invention can thus be made ready for use on site, for example, on a building site, by mixing the two components A and B.

The object of the invention is also achieved by the use of the two-component anticorrosion paint according to any one of claims 1 to 18 for producing anticorrosion coatings.

The object of the invention is further achieved by the use of a two-component anticorrosion paint according to any one of claims 1 to 19 and a finishing paint for producing double-layer anticorrosion coatings.

The object of invention is also achieved by providing an anticorrosion coating consisting of a first coat produced from a two-component anticorrosion paint according to any one of claims 1 to 18 and a top coat.

Finally, the object of the invention is also achieved by an article provided with a two-component anticorrosion paint according to any one of claims 1 to 18 or an anticorrosion coating according to claim 26.

Preferred developments of the invention are defined in respective subclaims.

The inventors have succeeded, surprisingly, in replacing the hitherto usual quadruple-layer paint structure with a double-layer structure. It has also been found, surprisingly, that the use of a combination of a special epoxy compound, namely an epoxysilane and/or an epoxy silicone, together with metal pigments comprising platelet-type zinc-containing metal pigments allows for the production of a stable and extremely durable two-component anticorrosion paint. The two-component anticorrosion paint of the invention exhibits such durability that it is possible to cut down on two of the three usual additional coats of paint.

The first coat consists of the two-component anticorrosion paint of the invention.

The second coat is formed by a finishing paint. The finishing paint is preferably a two-component polyurethane system. However, the two-component epoxysilane system used as undercoat can also be used as the top coat, but without pigmentation with zinc pigments.

The anticorrosion coating of the invention comprising only two layers is also suitable, surprisingly, for use as engineering corrosion protection, for example, on steel constructions such as railway bridges, lattice steel towers, or guardrails on freeways.

The two-component anticorrosion paint of the invention contains metal pigments, which are or comprise platelet-type zinc-containing metal pigments. In addition to the zinc-containing platelet-type metal pigments, it is possible for other metal pigments to be present. However, it has been found that at least 30% by weight of platelet-type zinc-containing metal pigments must be present in the two-component anticorrosion paint of the invention.

According to a preferred embodiment of the invention, the two-component anticorrosion paint contains zinc-containing metal dust and/or platelet-type aluminum-containing metal pigments in addition to the platelet-type zinc-containing metal pigments.

These metal pigments are anticorrosion pigments, the Zn-containing metal dust acting substantially electrochemically (sacrificial anode), the platelet-type aluminum-containing pigments acting as a barrier, and the platelet-type Zn-containing metal pigments combining said two active mechanisms.

According to a preferred embodiment, platelet-type zinc pigments are used as the platelet-type zinc-containing metal pigments, i.e., pigments that have a content of from 98 to 100% by weight of zinc. The content of platelet-type zinc-containing metal pigments, preferably platelet-type zinc pigments, in the two-component anticorrosion paint preferably ranges from 30 to 50% by weight and more preferably from 30 to 45% by weight, based on the total weight of the paint.

Zinc dust is preferably used as the zinc-containing metal dust. The zinc dust is preferably present in a finely divided form, for example, as granules or coarse powder. The particle diameter usually ranges from 0.5 to 150 μm and preferably from 2 to 80 μm. The zinc dust preferably has a zinc content of from 98 to 100% by weight. The content of zinc-containing metal dust, preferably zinc dust, in the two-component anticorrosion paint preferably ranges from 0 to 40% by weight and more preferably from 5 to 30% by weight, based on the total weight of the paint.

When use is made of a pigment mixture consisting of platelet-type zinc-containing metal pigments and zinc-containing metal dust, the ratio of the zinc-containing metal dust to the platelet-type zinc-containing metal pigments, by weight, preferably ranges from 0:1 to 1:1, more preferably from 0:1 to 0.5:1 and most preferably from 0.05; 1 to 0.3:1. A ratio of zinc-containing metal dust to platelet-type zinc-containing pigments ranging from 0.1:1 to 0.25:1, by weight, has proved to be very suitable.

A mixture of platelet-type zinc-containing metal pigments and zinc-containing metal dust can have advantageous effects, since the increased pigment-to-pigment contacts ensure better electrical conductivity in the cured anticorrosion layer.

When use is made of a pigment mixture consisting of platelet-type zinc-containing metal pigments and platelet-type aluminum-containing metal pigments, the ratio of the platelet-type aluminum-containing metal pigments to the platelet-type zinc-containing metal pigments, by weight, preferably ranges from 0:1 to 0.3:1, more preferably from 0:1 to 0.2:1 and most preferably from 0.05:1 to 0.15:1.

According to a preferred development of the invention, the two-component anticorrosion paint comprises or has the following compositions:
from 95 to 100% by weight of platelet-type zinc-containing pigments, based on the total weight of all metal pigments present; or
platelet-type zinc-containing metal pigments and zinc-containing metal dust, in which the ratio of the zinc-containing metal dust to the platelet-type zinc-containing metal pigments, by weight, ranges from 0:1 to 1:1 and the content of zinc in the platelet-type zinc-containing metal pigments and in the zinc-containing metal dust is in each case preferably at least 60% by weight, always based on the total weight of the platelet-type zinc-containing metal pigments and the zinc-containing metal dust respectively; or
platelet-type zinc-containing metal pigments and platelet-type aluminum-containing pigments, in which the ratio of the platelet-type aluminum-containing metal pigments to the platelet-type zinc-containing pigments, by weight, ranges from 0:1 to 0.3:1 and the content of zinc in the platelet-type zinc-containing metal pigments and the content of aluminum in the platelet-type aluminum-containing pigments is in each case preferably at least 60% by weight, always based on the total weight of the platelet-type zinc-containing metal pigments and the platelet-type aluminum-containing pigments respectively; or
platelet-type zinc-containing metal pigments, platelet-type aluminum-containing pigments and zinc-containing metal dust, in which the ratio of the platelet-type aluminum-containing pigments, the zinc-containing dust, and the platelet-type zinc-containing metal pigments to each other, by weight, ranges from 0:0:1 to 0.3:0.5:1 and the content of zinc in the platelet-type zinc-containing metal pigments, the content of aluminum in the platelet-type aluminum-containing pigments, and the content of zinc in the zinc-containing metal dust are in each case preferably at least 60% by weight, always based on the total weight of the platelet-type zinc-containing metal pigments, the platelet-type aluminum-containing pigments, and the zinc-containing metal dust respectively.

It is further preferable for the platelet-type zinc-containing metal pigments to have a zinc content of at least 75% by weight, more preferably at least 85% by weight and most preferably at least 95% by weight, always based on the weight of the platelet-type zinc-containing metal pigment.

Platelet-type aluminum-containing metal pigments, even if present in relatively small amounts, superbly complement the anticorrosion effect of the overall anticorrosion coating, due to their barrier effect. Since aluminum-containing pigments or aluminum pigments cannot participate reliably as the sacrificial anode for providing protection from corrosion, due to their highly passivating oxide layer, it is preferred, according to the invention, to fix a limit to the content of platelet-type aluminum-containing pigments in the two-component anticorrosion paint of the invention. A content of from 0 to 15% by weight and preferably from 5 to 10% by weight has proved to be very suitable, the percentages being based on the total weight of the two-component anticorrosion paint.

The platelet-type aluminum-containing pigments are preferably platelet-type aluminum pigments, which are produced by grinding coarse aluminum powder having an aluminum content of from 98 to 100% by weight.

The metal pigments comprising platelet-type zinc-containing metal pigments can be added either to the epoxysilane component (component A) or to the amine curing agent (component B) or to both components. In a preferred variant, the metal pigments comprising platelet-type zinc-containing metal pigments are added exclusively to the epoxysilane component. The epoxysilane component is less reactive. When adding the metal pigments comprising platelet-type zinc-containing metal pigments to the amine curing agent or amine hardener, it is necessary to ensure substantial freedom from water, since otherwise it is almost impossible to prevent reaction thereof with the metal pigments.

The water content of the two-component anticorrosion paint is below 5% by weight, based on the total weight of the paint. In a preferred variant, the water content is below 3% by weight, and more preferably below 1% by weight, even more preferably below 0.5% by weight and most preferably below 0.3% by weight, always based on the total weight of the paint. These low water contents rule out premature oxidation of the metal pigments. Furthermore, they prevent uncontrolled reaction of the epoxysilanes.

The platelet-type zinc-containing metal pigments, preferably platelet-type zinc pigments used in the present invention have longitudinal dimensions, as determined by means of laser diffraction methods (preferably using Cilas 1064, supplied by Cilas), of preferably from 5 to 100 μm, more preferably from 8 to 80 μm and most preferably from 10 to 50 μm. These values refer to the d₅₀ value of the cumulative size distribution curve. The thickness of the pigments is from 0.05 to 5 μm and preferably from 0.1 to 1 μm.

The platelet-type zinc-containing metal pigments can also be present in the form of zinc alloys. Alloys of zinc with aluminum, tin, and/or manganese are preferred. The proportion of zinc in the zinc alloy is preferably at least 60% by weight and more preferably at least 80% by weight. Such zinc alloy pigments are produced by Doral, Switzerland.

The metal pigments comprising platelet-type zinc-containing metal pigments could be used in the form of substantially dry powders or pastes. The use of powders is preferred, since no organic solvents are introduced into the anticorrosion paint thereby. Common solvents in metal pigment pastes are hydrocarbons, such as petroleum spirit, or aromatic hydrocarbons, such as solvent naphtha. The type and quantity of the solvent used in the anticorrosion paint of the invention should be specified, in order to prevent uncontrolled accidental entry thereof via the components used.

Examples of solvents in the anticorrosion paint of the invention include alcohols, such as methanol, ethanol, and 1-butanol, or esters, preferably acetate esters, such as methoxybutyl acetate, aliphatic hydrocarbons, such as petroleum spirit, or aromatic hydrocarbons, such as xylene or solvent naphtha. Likewise, the use of mixtures of the aforementioned solvents is preferred.

According to a preferred development of the invention, at least one epoxysilane is a compound of the general formula (I)

R¹ₐR²_{b}SiX_{(4-a-b)} (I)

wherein R¹ stands for a non-hydrolyzable radical, R² for a non-hydrolyzable radical containing at least one epoxy group, and X for radicals that are the same or different and are selected from the hydroxyl group and hydrolyzable substitution products of a hydroxyl group, where a can be an integer from 0 to 3 and b can be an integer from 1 to 3, and a and b are together equal to 1, 2, or 3.

According to another preferred embodiment, the epoxysilane of the general formula (I) is present in oligomeric or polymeric form, the units being interlinked by means of Si—O—Si bridges.

In a preferred embodiment, a is equal to 0 and b is equal to 1.

The radical X consists preferably of OH groups, halogen groups, or alkoxy groups containing from 1 to 6, and preferably from 1 to 3, carbons. Alkoxy groups are preferred, and methylalkoxy and/or ethylalkoxy groups are especially preferred. In a preferred variant, the alcohol released during hydrolysis of the alkoxy groups is distilled off so that the epoxysilane is substantially free of solvents.

The group R² is preferably a glycidyl radical or a glycidyloxy-C₁-C₂₀)-alkylene radical. In particular, it is a β-glycidyloxyethyl radical, γ-glycidyloxypropyl radical, δ-glycidyloxybutyl radical, ε-glycidyloxypentyl radical, ω-glycidyloxyhexyl radical or 2-(3,4-epoxycyclohexyl)ethyl radical.

The group R¹ is preferably selected from the group consisting of (C₁-C₄₀)-alkyl, fluorinated (C₁-C₄₀)-alkyl, partially fluorinated (C₁-C₄₀)-alkyl; (C₂-C₄₀)-alkenyl, (C₂-C₄₀)-alkynyl; (C₆-C₃₆)-aryl, fluorinated (C₆-C₃₆)-aryl, partially fluorinated (C₆-C₃₆)-aryl; (C₇-C₄₀)-alkylaryl, (C₇-C₄₀)-arylalkyl, fluorinated (C₇-C₄₀)-alkylaryl, partially fluorinated (C₇-C₄₀)-alkylaryl; (C₈-C₄₀)-alkenylaryl, (C₈-C₄₀)-arylalkynyl, (C₈-C₄₀)-alkynylaryl; (C₈-C₄₀)-cycloalkyl, (C₅-C₄₀)-alkylcycloalkyl, and (C₅-C₄₀)-cycloalkylalkyl. When a is 2, the R¹ groups can be the same or different. However, they are preferably the same. Preferably, R¹ is methyl, ethyl, or propyl, or a is zero.

Being readily availability, oligomers of γ-glycidyloxypropyltrimethoxysilane or γ-Glycidyloxypropyltriethoxysilane or mixtures thereof are used as epoxysilanes and/or epoxy silicones. γ-Glycidyloxypropyltrimethoxysilane is commercially available, for example, under the name Dynasylan GLYMO supplied by Degussa (Untere Kanalstrasse 3, D-79618 Rheinfelden).

The epoxysilane or epoxysilane mixture used is preferably in liquid form at application temperatures ranging from approx. 0 to 40° C. Otherwise, it would be necessary to add solvents, which, however, should be kept to the lowest level possible in the anticorrosion paint of the invention. In the component A of the invention, the metal pigments comprising platelet-type zinc-containing metal pigments are dispersed in the preferably liquid epoxysilane without the necessity of adding other solvents. The component A is preferably solvent-free. The residues of alcohols that may remain following hydrolysis of the epoxysilanes and distillation of the alcohol, are preferably below 1% by weight, based on the total weight of the anticorrosion paint. The total solvent content is from 0 to not more than 40% by weight, preferably from 0.5 to 20% by weight, still more preferably from 0.5 to 10% by weight and most preferably from 0.6 to 5% by weight, based on the total weight of the anticorrosion paint.

In another preferred embodiment, a portion of the epoxysilane is caused to react with compounds having functionalities that react polymerically with epoxy groups. Examples of such functionalities include hydroxy, isocyanate, blocked isocyanate or amino groups. However, it is necessary for sufficient reactive epoxy groups to remain, after the reaction of the epoxysilane with such functional groups, in order to be available for the curing reaction with the amine curing agent or amine hardener.

In another preferred embodiment, a portion of the epoxysilane is initially hydrolyzed and oligomerized by means of a sol-gel process and then mixed with, and/or caused to react with, aromatic polyols. Such systems are described in DE 100 39 404 A1, which is incorporated herein by reference. In another preferred embodiment, the oligomerized epoxysilanes are mixed with, and/or caused to react with, bisphenol A and/or derivatives thereof. The molar ratio of the epoxy groups of the silane to the hydroxy groups of the aromatic polyol is, for example, from 1.1:1 to 2:1 and preferably from 1.2:1 to 1.6:1.

The epoxy groups must always outnumber the hydroxy groups in order to continue to be available for the additional subsequent curing process with the amine curing agent.

Furthermore, the epoxysilanes can also be mixed with, and/or caused to react with, other organofunctional silanes to form silicones.

Preferably, (C₁-C₄₀)-alkyl, fluorinated (C₁-C₄₀)-alkyl, partially fluorinated (C₁-C₄₀)-alkyl; (C₂-C₄₀)-alkenyl, (C₂-C₄₀)-alkynyl; (C₆-C₃₆)-aryl, fluorinated (C₆-C₃₆)-aryl, partially fluorinated (C₆-C₃₆)-aryl; (C₇-C₄₀)-alkylaryl, (C₇-C₄₀)-arylalkyl, fluorinated (C₇-C₄₀)-alkylaryl, partially fluorinated (C₇-C₄₀)-alkylaryl; (C₈-C₄₀)-alkenylaryl, (C₈-C₄₀)-arylalkynyl, (C₈-C₄₀)-alkynylaryl; (C₅-C₄₀)-cycloalkyl, (C₅-C₄₀)-alkylcycloalkyl, and (C₅-C₄₀)-cycloalkylalkyl silanes are used as organofunctional silanes. Such silanes additionally make the anticorrosion paint water-repellent and can thus increase its anticorrosion effect.

Furthermore, tetraalkoxysilanes and/or oligomer derivatives of these compounds can be added to the epoxysilanes. It is preferred to use, in particular, tetramethoxysilane and tetraethoxysilane as tetraalkoxysilanes. An example of a pre-hydrolyzed tetraalkoxysilane is TES 55 supplied by Wacker. This is an oligomer containing an average of nine silicon atoms. Furthermore, it is also possible to add to the epoxysilane SiO₂ particles having average diameters ranging from 1 to 40 nm and preferably from 5 to 20 nm. Due to their superficial silanol groups, these particles crosslink with the epoxysilanes and contribute to improvement of the mechanical properties of the anticorrosive paint of the invention.

It is alternatively possible to use epoxysilane mixtures as disclosed in U.S. Pat. No. 6,344,520, DE 19 35 471 A1, and U.S. Pat. No. 5,952,439, which are incorporated herein by reference. However, the excess alcohols must preferably be distilled off beforehand from the respective epoxysilane mixture until the solvent content is below 20% by weight, preferably below 10% by weight and most preferably below 5% by weight.

Epoxy silane paint components supplied by NTC (Nano Tech Coatings GmbH, Dirminger Straβe 17, D-66636 Tholey, Germany) are particularly suitable. Other suitable examples are the silicone product Silres HP 1000 supplied by Wacker (Wacker Silicones Division, 3301 Sutton Road, Adrian, Mich. 49221-9397, USA), in which phenylsilanes are oligomerized with epoxysilanes, or Silres HP 2000. Likewise, Silkoftal® ED supplied by Tego (Tego Chemie Service, Goldschmidtstraβe 100, D-45127 Essen, Germany) is suitable.

Component B substantially contains at least one amine curing agent or amine hardener. Basically, all prior amine curing agents can be used. For example, the amine curing agents used may be polyamines such as diethylenetriamine, triethylenetetramine, tetraethylenepentamine, pentaethylenehexamine, propylenediamine, dipropylenetriamine, bis(aminopropyl)-amine, 1,4-bis(3′-aminopropyl)piperazine, N,N-bis(3-aminopropyl)ethylenediamine, N,N,2,2-tetramethyl-1,3-propanediamine, N,N′,N″-trimethylethylenediamine, neopentanediamine, 2-methyl-1,5-pentanediamine, 1,3-diaminopentane, hexamethylenediamine, polyethyleneimines and cycloaliphatic amines such as isophoronediamine, 1,2- or 1,3-diaminocyclohexane, 1,4-diamino-3,6-diethylcyclohexane, 1-cyclohexyl-3,4-diaminocyclohexane, and 3-amino-1-cyclohexylaminopropane.

However, amino silanes are particularly preferred as amine curing agents. These are available commercially, for example, as many representatives of the products produced by Degussa, Rheinfelden and marketed under the trade name Dynasylan® or the Silquest® silanes produced by OSi Specialties or the GENOSIL® silanes produced by Wacker.

Examples thereof are aminopropyltrimethoxysilane (Dynasylan AMMO; Silquest A-1110), aminopropyltriethoxysilane (Dynasylan AMEO) or N-(2-aminoethyl)-3-aminopropyltrimethoxysilane (Dynasylan DAMO, Silquest A-1120) or N-(2-aminoethyl)-3-aminopropyltriethoxysilane, triamino-functional trimethoxysilane (Silquest A-1130), bis(gamma-trimethoxysilylpropyl)amine (Silquest A-1170), N-ethyl-gamma-aminoisobutyltrimethoxysilane (Silquest A-Link 15), N-phenyl-gamma-aminopropyltrimethoxysilane (Silquest Y-9669), 4-amino-3,3-dimethylbutyltrimethoxysilane (Silquest Y-11637), (N-cyclohexylaminomethyl)triethoxysilane (Genosil XL 926), (N-phenylaminomethyl)trimethoxysilane (Genosil XL 973), and mixtures thereof.

The amine curing agent is used in quantities of from 2 to 15% by weight, preferably from 6 to 12% by weight and more preferably from 7 to 10% by weight, based on the total weight of the two-component anticorrosion paint.

According to a preferred development, the two-component anticorrosion paint of the invention contains at least one plasticizing additive. The plasticizing additive is preferably added to component A. However, it can alternatively be added to component B or to both component A and component B. The at least one plasticizing additive is preferably selected from the group consisting of plasticizers, plasticizing resin, and mixtures thereof.

The at least one plasticizing additive is preferably present in quantities of from 1 to 15% by weight, more preferably from 2 to 10% by weight and most preferably from 3 to 8% by weight, based on the total weight of the two-component anticorrosion paint.

The plasticizers used can be conventional compounds such as primary plasticizers, e.g., plasticizers containing phthalic acid and trimellitic acid or esters thereof, or secondary plasticizers, for example, adipic acid esters, azelaic acid esters, sebacic acid esters, citrate esters or alkyl fatty acid esters, e.g. butyloleate or the butyl ester of acetylated ricinolic fatty acid.

Specifically, the following can be used, for example:

Dioctyl phosphate, diethyl phthalate, dibutyl phthalate, diisobutyl phthalate, di-2-ethylhexyl phthalate, dioctyl phthalate, diphenyl phthalate, dicyclohexyl phthalate, butylbenzyl phthalate, diisooctyl phthalate, dinonyl phthalate, diisononyl phthalate, diisodecyl phthalate, diisotridecyl phthalate, butylbenzyl phthalate, diisobutyl adipate, dioctyl adipate, di-2-ethylhexyl adipate, diisodecyl adipate, dibutyl sebacate, dioctyl sebacate, di-2-ethylhexyl sebacate, acetylbutyl citrate, tri-(2-ethylhexyl)trimellitate or tri-n-octyldecyl trimellitate.

Furthermore, epoxy plasticizers can preferably be used as plasticizers. Particularly, high-molecular epoxy plasticizers composed of epoxidized triglycerides as well as low-molecular types composed of epoxidized esters of tall oil fatty acid or oleic acid are preferred. Examples thereof are epoxidized soybean oil, epoxidized linseed oil, and epoxidized octyl oleate. Such plasticizers prevent the anticorrosion layer from becoming excessively brittle following curing of the epoxysilanes.

The term “plasticizing resins”, which are also sometimes referred to as “adhesive resins” refers to low-molecular to high-molecular resins, which as a rule are cross-linked with each other only linearly. Such compounds and their mechanism of action are described, for example, in H. Kittel, Lehrbuch der Lacke und Beschichtungen, Volume III, Verlag W. A. Colomb 1976. They are characterized in particular by their very high migration stability and are therefore particularly preferred.

They are preferably polyesters of long-chain dicarboxylic acids, for example, adipic acid, sebacic acid, azelaic acid, brassylic acid, and/or phthalic acid with diols, for example, 1,3-butanediol, 1,2-propanediol, 1,4-butanediol and/or 1,6-hexanediol or with glycols, for example, 1,2-propylene glycol, 1,3-butylene glycol, 1,4-butylene glycol, or neopentyl glycol. Such polyesters preferably have molecular weights of from 200 to 15,000 g/mol and more preferably from 1,800 to 13,000 g/mol. Furthermore, preferably low-molecular polyesters having a molecular weight of from 200 to 700 g/mol are preferred. High-molecular polyesters having a molecular weight of from 6,000 to 12,000 g/mol are likewise preferred. Examples thereof are adhesive resin LTW (plasticizing resin supplied by Creanova Spezialchemie GmbH, D-45764 Marl, Germany) or K-Flex XM-B301 (plasticizing resin, supplied by King Industries P.O. Box 588 Norwalk, Conn. 06852, Great Britain).

Furthermore, citric acid and acetyl tributyl citrate and tartaric acid esters or lactic acid esters can be used.

Preferably, plasticizers are used in the two-component anticorrosion paint of the invention. It has been found, surprisingly, that the anticorrosive effect can be substantially improved by increasing the flexibility of the cured anticorrosion film. It has also been found, surprisingly, that the adhesion of the anticorrosion composition of the invention to steel substrates is improved by the addition of plasticizers.

In another embodiment of the invention, the two-component anticorrosion paint can additionally contain additives such as dispersing agents, wetting agents, flow-control agents, surface-wetting agents, fillers, and/or other binders, such as reactive diluents.

Appropriate standard paint additives can be used as dispersing agents.

The quantity of additives used is preferably from 0 to 7% by weight, more preferably from 1 to 6% by weight and most preferably from 2 to 5% by weight, based on the total weight of the anticorrosion paint.

Examples of fillers used can include inorganic fillers such as talcum, mica, kaolin, etc.

The quantity of filler used is preferably from 0 to 10% by weight and more preferably from 0 to 5% by weight.

In the method of the invention for the production of the two-component anticorrosion paint, controlled oligomerization of the epoxysilanes to epoxy silicones can also be achieved by the addition of a suitable catalyst. Organic amines or, preferably, acids, such as acetic acid, can be used as catalysts. The catalyst may be added only in very small quantities of not more than 5% by weight, based on the epoxysilane and/or epoxy silicone.

The two-component anticorrosion paint of the invention is used for the production of anticorrosion coatings. The two-component anticorrosion paint is particularly suitable for providing engineering corrosion protection. Predominantly metallic substrates, such as steel or iron, serve as substrates. Examples of substrates include railway bridges or power line towers. Other applications are conceivable, particularly if the finishing paint likewise consists of the two-component paint, but without pigmentation with metal pigments comprising platelet-type zinc-containing metal pigments. This two-component paint has anti-fouling properties, i.e. properties inhibiting the growth of algae. Thus, it can be used as ship primers or for painting harbor basin facilities.

In particular, the two-component anticorrosion paint of the invention and a finishing paint are used for the production of double-layered anticorrosion coatings.

The two-component anticorrosion paint is applied to the substrate by brushing, roller-coating or spraying, and preferably by airless spraying. The substrate can be preferably cleaned beforehand, cleaning by sandblasting being preferred.

The object of the present invention is thus also an anticorrosion coating, which consists of a first coat produced with the two-component anticorrosion paint of the invention, and an additional top coat.

Furthermore, the present invention also relates to articles provided with a two-component anticorrosion paint, such as painted poles, bridges, bridge parts, structural components, building parts, etc.

The layer thickness of the overall anticorrosion coating is extremely low and is only from 150 to 250 μm and preferably from 160 to 200 μm. By contrast, distinctly higher layer thicknesses are common in quadruple-layered anticorrosion coatings known from the prior art. This is evidenced, inter alia, in the Standard DIN EN ISO 12944-5, corrosion category C5-I (long), which prescribes a minimum total layer thickness of from 240 to 500 μm for epoxy systems.

The advantages of the double-layered anticorrosion coating of the invention are as follows:
saves time, since application thereof requires half the time taken for a quadruple-layered anticorrosion coating.
lower personnel costs due to the markedly reduced painting effort required; personnel costs constitute by far the major portion of the costs (approx. 90%) with the commonly used cheap anticorrosion coatings:
reduced weight on the coated object. A railway bridge of standard size needs, on average, several tons of paint in order to be coated with four layers. When using the two-component anticorrosion paint of the invention, it is possible to cut down on about half the paint otherwise used for the same bridge.

The following examples illustrate the invention, but without restricting it.

### EXAMPLE 1 OF THE INVENTION

### Two-Component Anticorrosion Paint

### Component A:

### Epoxy Silane Parent Component 1:

535 g of γ-glycidyloxypropyltrimethoxysilane (GPTS) are placed in the batch vessel and 61.5 g of 0.1 M HCl are added with stirring. An exothermic reaction takes place and the batch heats up within a few minutes and becomes a single phase. After 10 min, 203.5 g of bisphenol-A are added slowly and dissolved with continued stirring. The mixture is heated to 80° C., and 174 g of alcohol (methanol) are distilled off.

The water content of the mixture was determined by the Karl Fischer method and was less than 1% by weight of water. 40 g of Zinc Flake GTT (platelet-type zinc powder, d₅₀=13 μm, supplied by Eckart GmbH & Co. KG) and 10 g of Standart Lack NAT NL (aluminum flake powder, d₅₀=40 μm, supplied by Eckart GmbH & Co. KG) were placed in a plastic cup. The following materials were added successively while initially stirring gently and then stirring more vigorously (dissolver speed up to 2,000 rpm):
2 g of Byk 180 (viscosity-reducing wetting and dispersing agent supplied by Byk-Chemie GmbH, P.O. Box 100245, D-46462 Wesel, Germany)
16.4 g of epoxysilane parent component 1 (available at NTC Nano Tech Coatings GmbH, Dirminger Straβe 17, D-66636 Tholey, Germany)

The mixture was then stirred until a completely homogeneous dispersion was obtained. Then the following were added successively with stirring:
4 g of K-Flex XM-B301 (plasticizing resin supplied by King Industries P.O. Box 588 Norwalk, Conn. 06852, Great Britain
1 g of Modaflow Resin (flow-control agent supplied by Solutia, St. Louis, Mo., 63141, USA),
17 g of epoxysilane parent component 1,
0.5 g of Byk 333 (substrate wetting agent), and
0.5 g of Disperbyk 163 (wetting agent),

Then all components were stirred for 10 min. at 1,500 rpm.

### Component B:

8.6 g of g-aminopropyltrimethoxysilane (Dynasilan AMEO supplied by Degussa) were used for this component.

### EXAMPLE 2 OF THE INVENTION

### Two-Component Anticorrosion Paint

Similar to Example 1 of the invention, except that only 32 g of Zinc Flake GTT, instead of 40 g of Zinc Flake GTT, and additionally 8 g of zinc dust (Zinkstaub 17640 supplied by Doral, Switzerland) were used.

### EXAMPLE 3 OF THE INVENTION

### Two-Component Anticorrosion Paint

Similar to Example 1 of the invention, except that equal amounts of epoxysilane parent component 2 were used instead of the epoxysilane parent component 1. The epoxysilane parent component 2 used is the siloxane binder Silikoftal® ED (supplied by Tego Chemie Service GmbH, Goldschmidtstrasse 100, D-45127 Essen, Germany). The solids content is from 97.5 to 99.5% by weight.

### EXAMPLE 4 OF THE INVENTION

### Two-Component Anticorrosion Paint

Similar to Example 2 of the invention, except that equal amounts of epoxysilane parent component 2 (Silikoftal® ED) were used instead of the epoxysilane parent component 1.

### EXAMPLE 5 OF THE INVENTION

### Two-Component Anticorrosion Paint

Similar to Example 1 of the invention, except that equal amounts of epoxysilane parent component 3 were used instead of the epoxysilane parent component 1. The epoxysilane parent component 3 used is the siloxane binder Silres HP 1000 (supplied by Wacker, Burghausen, Germany).

### EXAMPLE 6 OF THE INVENTION

### Two-Component Anticorrosion Paint

Similar to Example 2 of the invention, except that equal amounts of epoxysilane parent component 3 (Silres HP 1000) were used instead of the epoxysilane parent component 1.

### COMPARATIVE EXAMPLE 7

Commercially available zinc dust primer: EMD 152 grey (supplied by Chemische Industrie, Erlangen, Germany).

In the following, the two-component anticorrosion paints of Examples 1 to 7 were applied to steel sheets that had been sandblasted to grade Sa 2½. When viewed without magnification, the surface of the steel sheets was required to be free from visible oil, grease, and dirt and adequately free from scale, rust, coatings, and foreign matter so that any remaining traces are at best visible as light shadows or flecks or slight streaks.

The following table gives an overview of the systems used:

TABLE 1
Overview of the applications

| | | | Coating | Coating | Total |
|---|---|---|---|---|---|
| | Undercoat | | thickness | thickness | coating |
| | used | Top coat | Undercoat | Top coat | thickness |
| Example | (primer) | used | [μm] | [μm] | [μm] |
| Example 8 of | Example 1 of | 2C | 100 | 80 | 180 |
| the invention | the invention | polyurethane | | | |
| | | system* | | | |
| Example 9 of | Example 1 of | Parent | 100 | 80 | 180 |
| the invention | the invention | component 1 | | | |
| | | and | | | |
| | | component B | | | |
| | | from Example | | | |
| | | 1 of the | | | |
| | | invention | | | |
| Example 10 of | Example 2 of | 2C | 120 | 80 | 200 |
| the invention | the invention | polyurethane | | | |
| | | system* | | | |
| Example 11 of | Example 3 of | 2C | 110 | 83 | 193 |
| the invention | the invention | polyurethane | | | |
| | | system* | | | |
| Example 12 of | Example 4 of | 2C | 125 | 78 | 203 |
| the invention | the invention | polyurethane | | | |
| | | system* | | | |
| Example 13 of | Example 5 of | 2C | 100 | 80 | 180 |
| the invention | the invention | polyurethane | | | |
| | | system* | | | |
| Example 14 of | Example 6 of | 2C | 110 | 80 | 190 |
| the invention | the invention | polyurethane | | | |
| | | system* | | | |

*ADH47 RAL 7030 Ching PU top coat containing curing agent D101 (supplied by Chemische Industrie, Erlangen, Germany)
2C = two-component

### COMPARATIVE EXAMPLE 15

A classical anticorrosion system complying to DIN EN ISO 12944-5 (C5-I long) was used, which has been approved by the BASt (German Federal Highway Research Institute).

This anticorrosion system is a quadruple-layer structure consisting of:
Zinc dust primer from Comparative Example 7 containing curing agent M 026; thickness of the dry layer: 80 μm
Intermediate coat 1 (micaceous iron oxide) Ching EP micaceous iron oxide-finishing paint EMD 30-HS grey DB703K containing curing agent M 031; thickness of dry layer: 160 μm
Intermediate coat 2 (micaceous iron oxide) Ching-EP-micaceous iron oxide—finishing paint EMD 40-HS grey DB704K containing curing agent M 040; thickness of dry layer: 160 μm
2C PU finishing paint (Ching-PUR top coat, ADH47 RAL 7030, containing curing agent D101; thickness of dry layer: 80 μm

All components are supplied by Chemische Industrie, Erlangen, Germany.

### COMPARATIVE EXAMPLE 16

The same structure as in Comparative Example 15 was used, but without the second intermediate coat. This structure is a triple-layer structure, consisting of:
Zinc dust primer (from Comparative Example 7); thickness of dry layer: 80 μm
Intermediate coat 1 (micaceous iron oxide) thickness of dry layer: 160 μm
2C PU finishing paint; thickness of dry layer: 80 μm

The sheets of Comparative Examples 16 and 17 were stored in ethyl acetate after the sandblasting process. Just before the first application of paint, the sheets were taken out and blown dry with compressed air. The primer was applied using a horsehair brush and the required coating thickness was determined using a wet film thickness gage.

The primer was dried for 24 hours at room temperature before the other coats (intermediate coats and top coat) were applied. Each layer was dried for 24 hours before the next application.

Before the finished sheet was subjected to the stress tests (salt spray test, condensation water test, etc.), it was stored for 1 week at room temperature.

### Application of the Examples of the Invention:

The sheets were stored in ethyl acetate after the sandblasting process. Just before the first application of paint, the sheets were taken out and blown dry with compressed air. The primer was applied using a HVLP hand-held spray gun (supplied by SATA) using a nozzle size of 2.5 mm.

### Humidity: 60%

### Temperature: 23° C.

Air pressure (pistol): 4 bar

The primer was then dried for 24 hours at room temperature. After the primer had dried, the 2C PU finishing paint was likewise applied using a HVLP hand-held spray gun (supplied by SATA) and a 1.3 mm nozzle size, and dried for 24 hours at room temperature.

Before the finished sheet was subjected to the stress tests (salt spray test, condensation water test, etc.), it was stored for 1 week at room temperature.

The test sheets were examined according to the test specification ISO 12944 C5-I long. “I” stands for “industrial atmosphere” (atmosphere contaminated by the discharge of local or regional corrosive industrial waste gases, particularly sulfur dioxide).

### This Examination Covers:

the effect of chemicals (ISO 2812-1), supplemented by ISO 3231.
the condensation of water vapor (ISO 6270)
the effect of neutral salt spray fog (ISO 7253)

The following table shows the duration of the stress periods:

| | | |
|---|---|---|
| salt spray fog | 2160 hours | (90 days) |
| water vapor | 720 hours | (30 days) |
| Kesternich test | 30 cycles | (30 days) |

### Description of the Individual Tests:

### a) Condensation of Water Vapor.

The sheets to be tested were stored for 24 hours after paint application and curing, in order to ensure that the coatings were fully cured. The condensation water test as specified by DIN 50017 is performed under high levels of humidity. The effect of condensed water vapor on the coating is thus examined. The sample (T<40° C.) is in a saturated water vapor atmosphere (40° C.), so that there is condensation of the air moisture on the coating.

The edges of the sheets to be tested were masked with adhesive tape (Tesafilm) before this test in order to prevent water from seeping beneath the paint from the rear.

The objective is to examine whether blisters form on the paint film or white spots appear. A cross-cut test is performed on the thus exposed sheets immediately after, and 24 hours after, the conclusion of the test. The test sheets are graded in accordance with the standard assessment of GT 0-5 (DIN 50017), GT 0 representing “very good” and GT 5 being “very poor”.

### b) Effect of Neutral Salt Spray Fog:

The sheets to be tested were stored for 24 hours after application and curing of the coatings, in order to ensure that the latter had cured fully. The salt spray test is a corrosion test standardized in DIN 50021 and, especially for the painting sector, in DIN 53167. In this corrosion test, a finely sprayed sodium chloride solution is allowed to act on the sample. 1.5 ml/h of the solution is sprayed with the help of moisturized compressed air onto a tilted sample at 40° C., based on a surface area of 80 cm².

The edges of the sheets to be tested were masked with adhesive tape before this test in order to prevent water vapor from seeping beneath the paint from the rear.

The test was carried out on coated samples having specific weak points. Damage occurs at weak points and is evaluated on the basis of the degree of seepage.

### c) Effect of Chemicals (Kesternich Test):

The Kesternich test comprises subjecting the test sheets to the alternating load of the condensation water test and SO₂ atmosphere. It is performed in accordance with DIN 50018. After the test sheets have been subjected to these stresses, the average value of mass loss is determined and indicated in g/m². The deviation of the individual values must not exceed 20%. However, the sheets are evaluated mainly based on their visual impression (white discoloration).

### Cross-Cut Test:

This is a method used to determine the adhesive strength of coatings. In accordance with DIN ISO 2409, at least 6 parallel cuts are made with a sharp blade through a coating or a multilayer coating cutting through to the respective substrate and then at least 6 parallel cuts are made at right angles thereto, again cutting through to the substrate. The distance between the parallel cuts varies with the thickness of the respective coating, but is at least 1 mm. Then an adhesive tape of a specific type, e.g. Tesafilm, is applied to the surface using slight pressure and then peeled off abruptly. The number of squares of coating that are peeled off on removal of the adhesive tape is assessed if these had not already chipped off when performing the cross-cuts. The adhesive strength of the tested coatings is graded using characteristic values ranging from 0=very good to 5=very poor. These values are determined by a comparison with relevant reference diagrams.

As already mentioned, the width of the space between the cuts depends on the layer thickness. With a layer thickness of:

0-60 μm −> 1 mm spacing
60-120 μm −> 2 mm spacing
>120 μm −> 3 mm spacing

In the present case, the cross-cut grid would have required a mesh width of 3 mm. However, a cross-cut grid with a mesh width of 2 mm was used in order to emphasize the results and to bring out the differences in coating qualities more clearly under more stringent conditions.

### Test Results:

### Condensation Water Test:

The sheets were subjected to the condensation water test in accordance with DIN 50017 and subjected to a cross-cut test immediately after, one hour after, and 24 hours after the conclusion of the test.

TABLE 2
Results of condensation water test (cross-cut)

| | Sheet 1 | | | Sheet 2 | | | Sheet 3 | | |
|---|---|---|---|---|---|---|---|---|---|
| Sample | 0 h | 1 h | 24 h | 0 h | 1 h | 24 h | 0 h | 1 h | 24 h |
| Example 8 of | GT 1 | GT 1 | GT 1 | GT 2 | GT 1 | GT 1 | GT 1 | GT 1 | GT 2 |
| the invention | | | | | | | | | |
| Example 9 of | GT 1 | GT 1 | GT 0 | GT 2 | GT 1 | GT 1 | GT 1 | GT 1 | GT 1 |
| the invention | | | | | | | | | |
| Example 10 of | GT 2 | GT 1 | GT 1 | GT 2 | GT 1 | GT 1 | GT 1 | GT 1 | GT 1 |
| the invention | | | | | | | | | |
| Example 11 of | GT 2 | GT 1 | GT 1 | GT 2 | GT 1 | GT 1 | GT 2 | GT 1 | GT 1 |
| the invention | | | | | | | | | |
| Example 12 of | GT 2 | GT 2 | GT 1 | GT 2 | GT 2 | GT 1 | GT 2 | GT 1 | GT 1 |
| the invention | | | | | | | | | |
| Example 13 of | GT 2 | GT 2 | GT 1 | GT 2 | GT 1 | GT 1 | GT 2 | GT 1 | GT 1 |
| the invention | | | | | | | | | |
| Example 14 of | GT 2 | GT 2 | GT 1 | GT 2 | GT 2 | GT 1 | GT 2 | GT 2 | GT 1 |
| the invention | | | | | | | | | |
| Comparative | GT 4 | GT 4 | GT 4 | GT 4 | GT 3 | GT 3 | GT 3 | GT 1 | GT 2 |
| example 15 | | | | | | | | | |
| Comparative | GT 4 | GT 2 | GT 2 | GT 3 | GT 3 | GT 3 | GT 3 | GT 3 | GT 3 |
| example 16 | | | | | | | | | |

The anticorrosion coatings of the examples of the invention displayed far better adhesion than the anticorrosion coating according to Comparative Example 15. There was no blistering or visible change in color on any sheet of the examples of the invention.

### Salt Spray Test:

The sheets were examined in accordance with DIN 53167 and then subjected to a cross-cut test.

Furthermore, the sheets were provided with an anticorrosion coating having a total coating thickness of 100 μm in order to determine a possible minimum coating thickness required for effective corrosion protection. The degree of rusting was indicated as well as the extent of seepage at defined damaged areas.

TABLE 3
Results of the salt spray test

| | Degree of rusting | | | Infiltration | | | | | |
|---|---|---|---|---|---|---|---|---|---|
| | *0-5* | | | [mm] | | | Cross-cut | | |
| | Sheet | Sheet | Sheet | Sheet | Sheet | Sheet | Sheet | Sheet | Sheet |
| Sample | 1 | 2 | 3 | 1 | 2 | 3 | 1 | 2 | 3 |
| Example 8 of | 1 | 1 | 0 | 0 | 0 | 0 | GT 1 | GT 1 | GT 2 |
| the invention | | | | | | | | | |
| Example 9 of | 1 | 0 | 1 | 0 | 0 | 0 | GT 3 | GT 3 | GT 2 |
| the invention | | | | | | | | | |
| Example 10 of | 1 | 1 | 1 | 1 | 1 | 0 | GT 1 | GT 1 | GT 2 |
| the invention | | | | | | | | | |
| Example 11 of | 1 | 1 | 0 | 1 | 1 | 0 | GT 1 | GT 1 | GT 2 |
| the invention | | | | | | | | | |
| Example 12 of | 1 | 1 | 1 | 1 | 1 | 1 | GT 1 | GT 1 | GT 2 |
| the invention | | | | | | | | | |
| Example 13 of | 1 | 1 | 0 | 1 | 1 | 0 | GT 1 | GT 1 | GT 2 |
| the invention | | | | | | | | | |
| Example 14 of | 2 | 1 | 1 | 1 | 1 | 1 | GT 1 | GT 1 | GT 2 |
| the invention | | | | | | | | | |
| Comparative | 2 | 1 | 2 | 10 | 9 | 8 | GT 4 | GT 3 | GT 4 |
| Example 15 | | | | | | | | | |
| Comparative | 2 | 2 | 2 | 6 | 7 | 7 | GT 3 | GT 4 | GT 3 |
| Example 16 | | | | | | | | | |

Evaluation of the degree of rusting and seepage shows that the anticorrosion coatings of the examples of the invention are clearly superior to those of the comparative examples. The absence of seepage in the anticorrosion coatings of the examples of the invention also limited the oxidization to a smaller surface area of the test sheet. Particularly in the coated test sheets of Comparative Example 16 (without the second intermediate layer), blisters formed after only 1000 h of salt spraying. However, on completion of the test there was no substantial difference to be seen compared with the coated test sheets of Comparative Example 16.

In view of the results of the cross-cut test, it is clear that the coated test sheets of the examples of the invention are superior to those of the comparative examples. The difference in adhesion between the “NTC structure with NTC top coat” compared with the normal NTC structure can be attributed to the extreme hardness of the paint system.

In terms of seepage, all NTC/Eckart structures are distinctly superior to the “S.d.T.” system. This can be attributed to the use of zinc flakes, since zinc dust tends to cause blistering.

### Effect of Chemicals (Kesternich Test):

The sheets were examined in accordance with DIN 50018 and then graded visually. The grading ranged from 0 (no change) to 5 (full white discoloration).

The sheets were graded on completion of half of the test cycles and at the end of the test.

TABLE 4
Results of the Kesternich test

| | After 15 cycles | | | After 30 cycles | | |
|---|---|---|---|---|---|---|
| Sample | Sheet 1 | Sheet 2 | Sheet 3 | Sheet 1 | Sheet 2 | Sheet 3 |
| Example 8 of | 2 | 2 | 1 | 2 | 2 | 2 |
| the invention | | | | | | |
| Example 9 of | 0 | 0 | 1 | 0 | 0 | 1 |
| the invention | | | | | | |
| Example 10 of | 2 | 2 | 1 | 2 | 2 | 2 |
| the invention | | | | | | |
| Example 11 of | 2 | 2 | 2 | 2 | 2 | 2 |
| the invention | | | | | | |
| Example 12 of | 2 | 2 | 2 | 2 | 2 | 2 |
| the invention | | | | | | |
| Example 13 of | 2 | 2 | 1 | 2 | 2 | 2 |
| the invention | | | | | | |
| Example 14 of | 2 | 2 | 2 | 2 | 2 | 2 |
| the invention | | | | | | |
| Comparative | 3 | 3 | 2 | 3 | 3 | 3 |
| Example 15 | | | | | | |

After 15 cycles or days of the Kesternich test, the samples of the examples of the invention are distinctly better than that of the comparative example. They display almost no change compared with the reference sample. By contrast, however, white streaks could be seen in the sample of the comparative example, indicating degradation of the binding agent.

In conclusion, it must be pointed out, in particular, that the excellent results of the coated test sheets of the examples of the invention are achieved using only double-layered anticorrosion coating structures, the total coating thickness of which is substantially less than that of the coated test sheets of Comparative Examples 15 and 16 (quadruple-layer and triple-layer structures, respectively).

The present invention thus provides an anticorrosion coating which requires only two coats of paint and can thus be applied in a shorter period of time and with much less effort and which affords significantly improved resistance to corrosion than is possible using triple-layered or quadruple-layered coatings known from the prior art. Particularly in the case of large objects, for example, bridges, buildings, cell phone towers, guard rails, hulls, etc., the present invention produces dramatic savings in terms of the cost of labor and materials.

1. A two-component anticorrosion paint comprising a metal pigment, an epoxy binder component, and an amine curing agent,
wherein
said two-component anticorrosion paint comprises two components A and B, of which
Component A comprises
(a1) (x−y)% by weight of metal pigments comprising platelet-type zinc containing metal pigments, where x is 30 to 70,
(a2) from 10 to 50% by weight of at least one epoxysilane and/or epoxy silicone, and
(a3) from 0 to 40% by weight of an organic solvent,
and
Component B comprises
(b1) from 2 to 15% by weight of at least one amine curing agent,
(b2) y % by weight of metal pigments comprising platelet-type zinc-containing metal pigments, where y is from 0 to x % by weight,
(b3) from 0 to 40% by weight of an organic solvent,
the percentages being based on the total weight of the two-component anticorrosion paint and total 100% by weight, with the proviso that the total water content of the two-component anticorrosion paint is not more than 5% by weight, the total content of solvent is not more than 40% by weight, and the total content of the platelet-type zinc-containing metal pigments is at least 20% by weight

2. The two-component anticorrosion paint according to claim 1, wherein
said at least one epoxysilane is a compound of the general formula (I):
R¹ₐR²_{b}SiX_{(4-a-b)} (I)
wherein R¹ stands for a non-hydrolyzable radical, R² for a non-hydrolyzable radical carrying at least one epoxide ring and X stands for the same or different radicals selected from the hydroxyl group and hydrolyzable substitution products of a hydroxyl group, and wherein a is an integer from 0 to 3 and b is an integer from 1 to 3 and a and b are together equal to 1, 2, or 3, or an Si—O—Si-bridged oligomeric or polymeric epoxysilicone derived from the compound defined by formula (I).

3. The two-component anticorrosion paint according to claim 1,
wherein
said at least one epoxysilane and/or epoxysilicone is mixed with, and/or caused to react with, at least one polyol, preferably bisphenol A or a derivative thereof.

4. The two-component anticorrosion paint according to claim 1,
wherein
the amine curing agent comprises aminosilanes and preferably consists of aminosilanes.

5. The two-component anticorrosion paint according to claim 1,
wherein
the metal pigments comprise, in addition to the platelet-type zinc-containing metal pigments zinc-containing, at least one of metal dust, platelet-type aluminum-containing metal pigments and mixtures thereof.

6. The two-component anticorrosion paint according to claim 1,
wherein
the metal pigments comprise the following compositions:
from 95 to 100% by weight of platelet-type zinc-containing pigments, based on the total weight of all metal pigments present; or
platelet-type zinc-containing metal pigments and zinc-containing metal dust, in which the ratio of the zinc-containing metal dust to the platelet-type zinc-containing metal pigments, by weight, ranges from 0:1 to 1:1 and the content of zinc in the platelet-type zinc-containing metal pigments and in the zinc-containing metal dust is in each case preferably at least 60% by weight, always based on the total weight of the platelet-type zinc-containing metal pigments and the zinc-containing metal dust respectively; or
platelet-type zinc-containing metal pigments and platelet-type aluminum-containing pigments, in which the ratio of the platelet-type aluminum-containing metal pigments to the platelet-type zinc-containing pigments, by weight, ranges from 0:1 to 0.3:1 and the content of zinc in the platelet-type zinc-containing metal pigments and the content of aluminum in the platelet-type aluminum-containing pigments is each preferably at least 60% by weight, always based on the total weight of the platelet-type zinc-containing metal pigments and the platelet-type aluminum-containing pigments respectively; or
platelet-type zinc-containing metal pigments, platelet-type aluminum-containing pigments and zinc-containing metal dust, in which the ratio of the platelet-type aluminum-containing pigments, the zinc-containing dust, and the platelet-type zinc-containing metal pigments to each other, by weight, ranges from 0:0:1 to 0.3:0.5:1 and the content of zinc in the platelet-type zinc-containing metal pigments, the content of aluminum in the platelet-type aluminum-containing pigments, and the content of zinc in the zinc-containing metal dust are in each case preferably at least 60% by weight, always based on the total weight of the platelet-type zinc-containing metal pigments, the platelet-type aluminum-containing pigments, and the zinc-containing metal dust respectively.

7. The two-component anticorrosion paint according to claim 1,
wherein
said platelet-type zinc-containing metal pigments have a zinc content of at least 75% by weight, based on the weight of said platelet-type zinc-containing metal pigment.

8. The two-component anticorrosion paint according to claim 1,
wherein said platelet-type zinc-containing metal pigments can comprise zinc alloys.

9. The two-component anticorrosion paint according to claim 8, wherein
said zinc alloys are alloys of zinc with aluminum, tin, manganese, or mixtures thereof.

10. The two-component anticorrosion paint according to claim 1,
wherein
the total content of platelet-type zinc-containing pigments in said two-component anticorrosion paint ranges from 30 to 50% by weight based on the total weight of the two-component anticorrosion paint.

11. The two-component anticorrosion paint according to claim 1,
wherein
the total content of platelet-type aluminum-containing pigments in said two component anticorrosion paint ranges from 0 to 15% by weight and preferably based on the total weight of the two-component anticorrosion paint.

12. The two-component anticorrosion paint according to claim 1,
wherein
the total content of zinc-containing metal dust in said two-component anticorrosion paint ranges from 0 to 40% by weight based on the total weight of said two-component anticorrosion paint.

13. The two-component anticorrosion paint according claim 1, wherein
the content of water is below 3% by weight based on the total weight of said two-component anticorrosion paint.

14. The two-component anticorrosion paint according to claim 1,
wherein
the content of solvent is below 20% by weight, based on the total weight of said two-component anticorrosion paint.

15. The two-component anticorrosion paint according to claim 1,
further comprising
at least one plasticizing additive, which plasticizing additive can be present in at least one of component A and component B.

16. The two-component anticorrosion paint according to claim 15, wherein
said at least one plasticizing additive is selected from the group consisting of plasticizer, plasticizing resin, and mixtures thereof.

17. The two-component anticorrosion paint according to claim 15,
wherein
said two-component anticorrosion paint contains at least one plasticizing additive up to a total of 15% by weight always based on the total weight of said two-component anticorrosion paint.

18. The two-component anticorrosion paint according to claim 1,
wherein
said two-component anticorrosion paint contains at least one further additive selected from the group consisting of such as dispersants, wetting agents, levelling agents, substrate wetting agents, fillers, and further binding agents.

19. The two-component anticorrosion paint according to claim 1,
wherein said
component A and said component B exist separately.

20. A method for the production of a two-component anticorrosion paint according to claim 1,
said method comprises the following steps:
a) taking from 10 to 50% by weight of epoxysilane, which may be optionally oligomerized or polymerized by the controlled addition of water,
b) taking from 2 to 15% by weight of an amine curing agent
c) homogenously mixing (x−y)% by weight of the metal pigments comprising platelet-type zinc-containing metal pigments, where x=30 to 70, with the epoxysilane, to form component A and y % by weight of metal pigments comprising platelet-type zinc-containing metal pigments with the amine curing agent, where y is from 0 to x % by weight, to form component B.

21. The method for the production of a two-component anticorrosion paint according to claim 20,
further comprising
adding solvents to at least one of component A and component B before, during or after the incorporation of said metal pigments comprising zinc-containing metal pigments, in amounts totaling not more than 40% by weight, based on the total weight of said two-component anticorrosion paint.

22. The method for the production of a two-component anticorrosion paint according to claim 20,
further comprising
adding at least one plasticizing component to at least one of component A and component B in a total amount of not more than 15% by weight, based on the total weight of said two-component anticorrosion paint.

23. The method for the production of a two-component anticorrosion paint according to claim 20,
further comprising
mixing component A and component B with each other.

24. The use of the two-component anticorrosion paint according to claim 1 for the production of anticorrosion coatings.

25. The use of a two-component anticorrosion paint according to claim 1 and also a finishing paint for the production of double-layer anticorrosion coatings.

26. An anticorrosion coating,
comprising
an undercoat produced with a two-component anticorrosion paint according to claim 1, and a top coat.

27. An object,
provided with a two-component anticorrosion paint according to claim 1.

28. An object, provided with a two-component anticorrosion paint according to an anticorrosion coating according to claim 26.
